(19) United States
(12) Patent Application Publication
(10) Pub. No.: US 2026/0049835 A1
(43) Pub. Date: Feb. 19, 2026

(54) SYSTEM

(71) Applicant: SoftBank Group Corp., Tokyo (JP)

(72) Inventor: Masashi ABE, Tokyo (JP)

(21) Appl. No.: 19/294,807

(22) Filed: Aug. 8, 2025

(30) Foreign Application Priority Data
Aug. 16, 2024 (JP) 2024-135995

(51) Int. Cl. G01C 21/00; G09B 21/00

(52) U.S. Cl. CPC G01C 21/3807; G01C 21/3885; G09B 21/007; G09B 21/009

(57) ABSTRACT

The system according to the embodiment includes an operation status acquisition unit, a tactile paving information acquisition unit, a map generation unit, and a voice guidance unit. The operation status acquisition unit acquires the operation status of each public transportation facility. The tactile paving information acquisition unit acquires tactile paving information from each local government. The map generation unit generates a map based on the information acquired by the operation status acquisition unit and the tactile paving information acquisition unit. The voice guidance unit provides voice guidance based on the map generated by the map generation unit.

### CROSS-REFERENCE TO RELATED APPLICATION

The present application claims priority to and incorporates by reference the entire contents of Japanese Patent Application No. 2024-135995 filed in Japan on Aug. 16, 2024.

### BACKGROUND OF THE INVENTION

### Field of the Invention

The technology of this disclosure relates to the system.

### Description of the Related Art

Japanese Patent Application Laid-open No. 2022-180282 discloses a persona chatbot control method executed by at least one processor, including: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that visually and hearing-impaired persons have difficulty reaching their destinations when using public transportation due to insufficient information on tactile paving and voice guidance.

### SUMMARY OF THE INVENTION

The system according to the embodiment includes an operation status acquisition unit, a tactile paving information acquisition unit, a map generation unit, and a voice guidance unit. The operation status acquisition unit acquires the operation status of each public transportation facility. The tactile paving information acquisition unit acquires tactile paving information from each local government. The map generation unit generates a map based on the information acquired by the operation status acquisition unit and the tactile paving information acquisition unit. The voice guidance unit provides voice guidance based on the map generated by the map generation unit.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

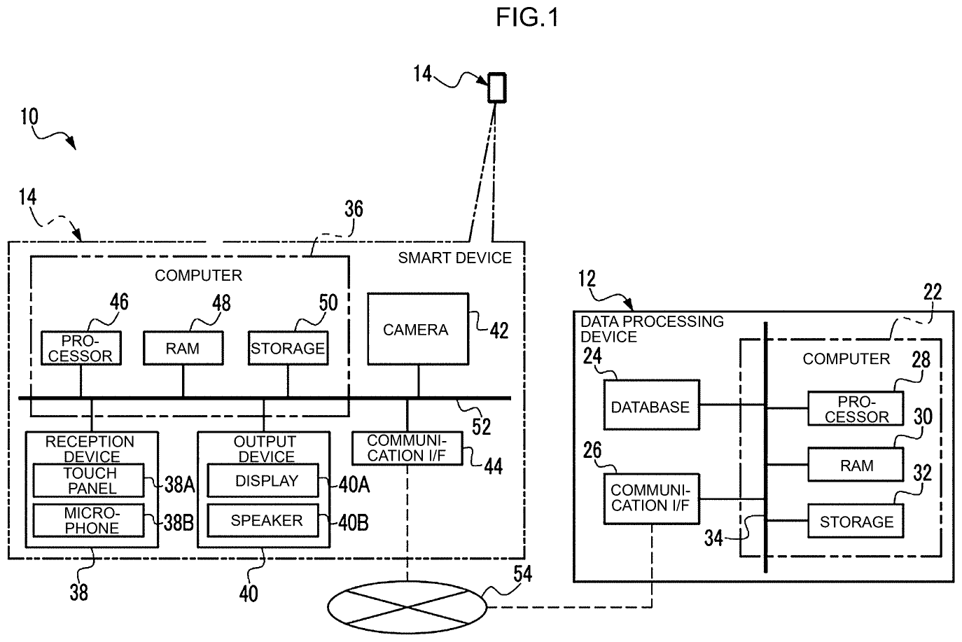

FIG. 1 shows an example configuration of a data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52.

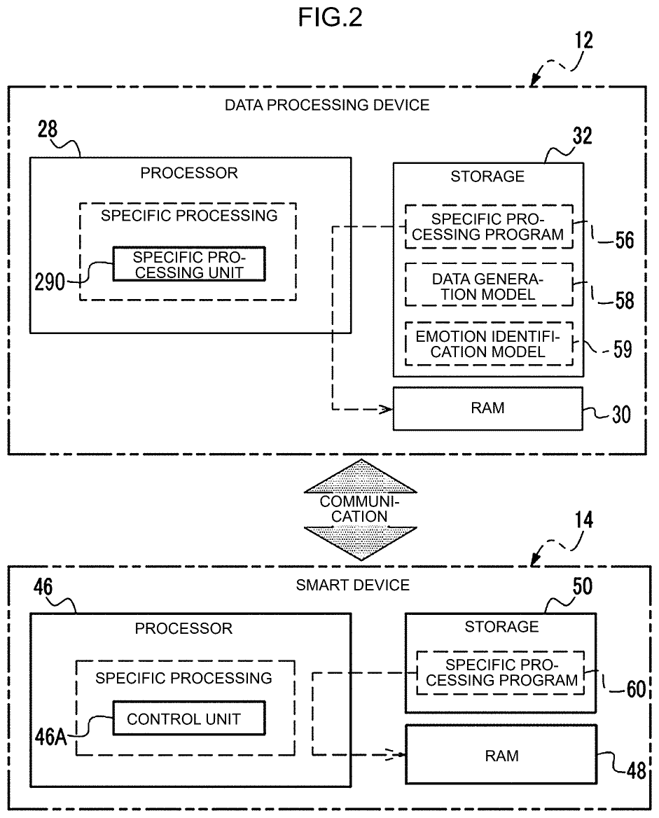

The reception device 38 includes a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 includes a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of Embodiment

The tactile paving MAP generation app according to the embodiment of the present invention is a system that supports visually and hearing-impaired persons in safely and efficiently reaching their destinations using public transportation. Thus, the tactile paving MAP generation app can support visually and hearing-impaired persons in safely and efficiently reaching their destinations using public transportation.

The tactile paving MAP generation app according to the embodiment includes an operation status acquisition unit, a tactile paving information acquisition unit, a map generation unit, and a voice guidance unit. The operation status acquisition unit acquires the operation status of each public transportation facility. For example, the operation status acquisition unit acquires train delay information in real time. The operation status acquisition unit can also acquire the operation status of buses. Furthermore, the operation status acquisition unit can also acquire the operation status of subways. For example, the operation status acquisition unit acquires transportation operation information via an API and updates it in real time. The tactile paving information acquisition unit acquires tactile paving information from each local government. For example, the tactile paving information acquisition unit acquires the installation locations of tactile paving. The tactile paving information acquisition unit can also acquire status information of tactile paving. Furthermore, the tactile paving information acquisition unit can also acquire update information of tactile paving. For example, the tactile paving information acquisition unit acquires tactile paving information from the local government database and reflects the latest information. The map generation unit generates a map based on the information acquired by the operation status acquisition unit and the tactile paving information acquisition unit. For example, the map generation unit uses generative AI to generate a map reflecting the latest operation status and tactile paving information. The map generation unit can also propose optimal routes based on past data. Furthermore, the map generation unit can generate detailed maps of station premises. For example, the map generation unit uses generative AI to generate detailed maps including the locations of elevators and escalators in the station premises. The voice guidance unit provides voice guidance based on the map generated by the map generation unit. For example, the voice guidance unit uses generative AI to generate voice guidance for visually and hearing-impaired persons. The voice guidance unit can also provide real-time voice guidance. Furthermore, the voice guidance unit can provide voice guidance according to the user's emotional state. For example, the voice guidance unit uses generative AI to analyze the user's emotional state and provide voice guidance that gives a sense of security. Thus, the tactile paving MAP generation app according to the embodiment can support visually and hearing-impaired persons in safely and efficiently reaching their destinations using public transportation. For example, the tactile paving MAP generation app provides route guidance based on the latest operation status and tactile paving information. By proposing optimal routes using past data, users can avoid congestion and move smoothly. With detailed maps of station premises and voice guidance, users can move without getting lost even in complex station premises.

The operation status acquisition unit can simultaneously collect weather and disaster information and propose safe routes to users. For example, when the generative AI collects operation status and tactile paving information, it acquires weather data in real time and proposes routes according to weather changes. For example, in the event of heavy rain or strong winds, indoor routes are preferentially guided. The operation status acquisition unit also collects disaster information and generates routes that respond to emergencies such as earthquakes and floods. For example, in the event of an earthquake, it proposes routes including evacuation routes. Furthermore, the operation status acquisition unit generates routes that allow users to move safely based on weather and disaster information and updates them in real time. For example, in the event of heavy rain, it guides users along routes with low flood risk. In this way, it is possible to provide users with routes that allow them to move safely.

The map generation unit can analyze the user's movement history and provide individually optimized routes. For example, the map generation unit uses generative AI to analyze the user's past movement history and propose individually optimized routes. For example, it generates routes considering routes used in the past and preferred means of transportation. The map generation unit also proposes routes to avoid congestion based on the user's movement history. For example, it predicts crowded time periods from past data and guides users to move during less crowded times. Furthermore, the map generation unit analyzes the user's movement history and proposes routes that include facilities and services preferred by the user. For example, it generates routes that pass by cafes or restaurants visited in the past. In this way, it is possible to provide users with individually optimized routes.

The map generation unit can also provide route guidance for elderly people and children other than visually and hearing-impaired persons. For example, the map generation unit uses generative AI to provide route guidance for elderly people based on collected information. For example, it proposes routes that prioritize the use of elevators and escalators. The map generation unit also generates safe routes for children using generative AI to provide route guidance for children. For example, it guides users along routes that pass through roads with little traffic or parks. Furthermore, the map generation unit collects barrier-free information using generative AI and provides it to users to offer route guidance for elderly people and children. For example, it proposes routes with few steps or with handrails. In this way, it is possible to provide route guidance for elderly people and children.

The map generation unit can also provide access information to tourist spots and event venues. For example, the map generation unit uses generative AI to collect information on tourist spots and provide access information for visually and hearing-impaired persons. For example, it proposes routes that include tactile paving and voice guidance information within tourist spots. The map generation unit also collects event information using generative AI to provide access information to event venues and generates optimal routes. For example, it guides users along routes that take into account congestion at event venues. Furthermore, the map generation unit collects real-time operation status of public transportation using generative AI to provide access information to tourist spots and event venues. For example, it proposes routes based on the operation status of trains and buses. In this way, it is possible to provide access information to tourist spots and event venues.

The map generation unit can analyze past data, learn the user's movement patterns, and predict future movements. For example, the map generation unit uses generative AI to analyze past movement data and learn the user's movement patterns. For example, it predicts routes used on specific days of the week or at specific times and proposes future movements. The map generation unit also predicts future movements based on the user's past movement history. For example, it predicts routes and time periods frequently used by the user from past data and proposes optimal routes. Furthermore, the map generation unit uses generative AI to analyze past data and learn the user's movement patterns to predict future movements. For example, it predicts movement patterns according to seasonal or weather changes and proposes routes. In this way, it is possible to predict the user's future movements and provide optimal routes.

The map generation unit can propose personalized routes that take into account the user's preferences and habits based on past data. For example, the map generation unit uses generative AI to analyze past data and learn the user's preferences and habits. For example, for users who prefer certain cafes or restaurants, it proposes routes that pass by those places. The map generation unit also proposes personalized routes based on the user's past movement history. For example, it generates routes considering routes used at specific times and preferred means of transportation. Furthermore, the map generation unit uses generative AI to propose routes that take into account the user's preferences and habits based on past data. For example, it generates routes that pass by scenic or quiet places preferred by the user. In this way, it is possible to provide personalized routes based on the user's preferences and habits.

The map generation unit can propose optimal routes from a global perspective by comparing the user's movement patterns in other cities or countries based on past data. For example, the map generation unit uses generative AI to analyze past data and compare the user's movement patterns in other cities or countries. For example, it proposes optimal routes based on movement data from different cities. The map generation unit also analyzes movement patterns in other countries and proposes optimal routes from a global perspective. For example, it generates routes that take into account different cultures and transportation systems. Furthermore, the map generation unit uses generative AI to compare the user's movement patterns in other cities or countries based on past data and propose optimal routes. For example, it guides users along routes that take into account congestion and transportation means in different cities. In this way, it is possible to provide optimal routes from a global perspective.

The map generation unit can provide route guidance according to specific events or seasons based on past data. For example, the map generation unit uses generative AI to analyze past data and provide route guidance according to specific events. For example, it proposes optimal routes during fireworks festivals or festivals. The map generation unit also provides route guidance according to the season by generating optimal routes based on past data using generative AI. For example, it guides users along routes that pass by cherry blossom viewing spots during the cherry blossom season. Furthermore, the map generation unit uses generative AI to provide route guidance according to specific events or seasons based on past data. For example, it proposes routes that pass by illumination spots during the Christmas season. In this way, it is possible to provide route guidance according to specific events or seasons.

The map generation unit can analyze real-time human flow when generating detailed maps of station premises and propose routes to avoid congestion. For example, the map generation unit uses generative AI to analyze real-time human flow when generating detailed maps of station premises and propose routes to avoid congestion. For example, it guides users along less crowded passages by avoiding crowded areas. The map generation unit also collects data from surveillance cameras and sensors in the station premises and analyzes real-time human flow. For example, it identifies areas where congestion is occurring and notifies users. Furthermore, the map generation unit uses generative AI to analyze real-time human flow and dynamically update routes to avoid congestion. For example, if congestion is resolved, it re-proposes the shortest route. In this way, it is possible to provide routes that avoid congestion.

The map generation unit can track the user's location information in real time when generating detailed maps of station premises and dynamically update routes. For example, the map generation unit uses generative AI to track the user's location information in real time and dynamically update detailed maps of station premises. For example, it recalculates the optimal route each time the user moves. The map generation unit also acquires location information from the user's smartphone or wearable device and provides real-time route guidance. For example, when the user approaches an elevator, it guides the next action. Furthermore, the map generation unit uses generative AI to dynamically update detailed maps of station premises based on the user's location information and propose optimal routes. For example, as the user approaches the destination, it finely adjusts the route. In this way, it is possible to track the user's location information in real time and dynamically update routes.

The map generation unit can also provide guidance for other complex facilities such as shopping malls and airports based on detailed maps of station premises. For example, the map generation unit uses generative AI to provide guidance for shopping malls based on detailed maps of station premises. For example, it proposes routes that include store locations, elevators, and escalator information. The map generation unit also generates detailed maps of airports using generative AI to provide guidance for airports. For example, it guides users to the locations of check-in counters and gates. Furthermore, the map generation unit uses generative AI to generate detailed maps of other complex facilities and provide guidance for visually and hearing-impaired persons. For example, it provides route guidance within large event venues or hospitals. In this way, it is possible to provide guidance for other complex facilities such as shopping malls and airports.

The map generation unit can provide visual guidance displays based on detailed maps of station premises and support users other than visually impaired persons. For example, the map generation unit uses generative AI to provide visual guidance displays based on detailed maps of station premises. For example, it displays guidance on digital signage or smartphone apps. The map generation unit also provides visual guidance displays using generative AI to support users other than visually impaired persons. For example, it provides guidance using maps or pictograms. Furthermore, the map generation unit uses generative AI to provide visual guidance displays based on detailed maps of station premises so that users can intuitively understand the guidance. For example, it displays guidance using color coding or icons. In this way, it is possible to provide visual guidance displays that support users other than visually impaired persons.

The system according to the embodiment is not limited to the above examples and can be variously modified, for example, as follows.

The tactile paving MAP generation app can further include a health status acquisition unit that monitors the user's health status. For example, the health status acquisition unit monitors the user's heart rate and blood pressure in real time and, if an abnormality is detected, proposes a route to the nearest medical facility. The health status acquisition unit can also analyze the user's walking speed and fatigue level and, if a break is needed, guide the user along a route that includes rest spots. Furthermore, the health status acquisition unit can generate a route that does not overburden the user based on the user's health data. For example, for users who have difficulty walking for long periods, it proposes routes that prioritize short-distance movement.

The tactile paving MAP generation app can further include a recommendation unit that proposes tourist spots and restaurants according to the user's preferences. For example, the recommendation unit analyzes the user's past visit history and evaluation data and proposes tourist spots that the user prefers. The recommendation unit can also guide the user to nearby restaurants and cafes based on the user's current location and movement route. Furthermore, the recommendation unit can provide event information according to the user's preferences. For example, if the user likes music events, it provides information on concerts held nearby.

The tactile paving MAP generation app can further include an emergency notification unit to ensure the user's safety during movement. For example, the emergency notification unit provides a function to call the police or ambulance with one touch when the user encounters an emergency. The emergency notification unit can also automatically send the user's current location to the notification destination to enable a prompt response. Furthermore, the emergency notification unit can include a function to send emergency notifications to the user's family or friends. For example, it sends a message including the current location and details of the emergency to a contact specified by the user.

The tactile paving MAP generation app can further include an entertainment unit that provides entertainment to the user during movement. For example, the entertainment unit provides a function to play music or audiobooks according to the user's preferences. The entertainment unit can also provide audio guidance on the history and culture related to the user's movement route. Furthermore, the entertainment unit can provide quizzes and games that the user can enjoy while moving. For example, it presents quizzes about places the user visits and introduces a system where points are accumulated for correct answers.

The tactile paving MAP generation app can further include a communication unit that supports communication for the user during movement. For example, the communication unit provides a function that allows the user to chat with other users in real time. The communication unit can also provide a function for the user to contact other users nearby. Furthermore, the communication unit can include a bulletin board function that allows the user to post questions or consultations while moving. For example, if the user gets lost, they can receive advice from other users.

Below is a brief explanation of the processing flow of Example 1 of the Embodiment.

Step 1: The operation status acquisition unit acquires the operation status of each public transportation facility. For example, it acquires train delay information, bus operation status, and subway operation status in real time. The operation status acquisition unit acquires transportation operation information via an API and updates it in real time.

Step 2: The tactile paving information acquisition unit acquires tactile paving information from each local government. For example, it acquires installation locations, status information, and update information of tactile paving. The tactile paving information acquisition unit acquires tactile paving information from the local government database and reflects the latest information.

Step 3: The map generation unit generates a map based on the information acquired by the operation status acquisition unit and the tactile paving information acquisition unit. For example, it uses generative AI to generate a map reflecting the latest operation status and tactile paving information. Furthermore, it can propose optimal routes based on past data or generate detailed maps of station premises.

Step 4: The voice guidance unit provides voice guidance based on the map generated by the map generation unit. For example, it uses generative AI to generate voice guidance for visually and hearing-impaired persons, and provides real-time voice guidance or voice guidance according to the user's emotional state.

### Example 2 of Embodiment

The tactile paving MAP generation app according to the embodiment of the present invention is a system that supports visually and hearing-impaired persons in safely and efficiently reaching their destinations using public transportation. Thus, the tactile paving MAP generation app can support visually and hearing-impaired persons in safely and efficiently reaching their destinations using public transportation.

The tactile paving MAP generation app according to the embodiment includes an operation status acquisition unit, a tactile paving information acquisition unit, a map generation unit, and a voice guidance unit. The operation status acquisition unit acquires the operation status of each public transportation facility. For example, the operation status acquisition unit acquires train delay information in real time. The operation status acquisition unit can also acquire the operation status of buses. Furthermore, the operation status acquisition unit can also acquire the operation status of subways. For example, the operation status acquisition unit acquires transportation operation information via an API and updates it in real time. The tactile paving information acquisition unit acquires tactile paving information from each local government. For example, the tactile paving information acquisition unit acquires the installation locations of tactile paving. The tactile paving information acquisition unit can also acquire status information of tactile paving. Furthermore, the tactile paving information acquisition unit can also acquire update information of tactile paving. For example, the tactile paving information acquisition unit acquires tactile paving information from the local government database and reflects the latest information. The map generation unit generates a map based on the information acquired by the operation status acquisition unit and the tactile paving information acquisition unit. For example, the map generation unit uses generative AI to generate a map reflecting the latest operation status and tactile paving information. The map generation unit can also propose optimal routes based on past data. Furthermore, the map generation unit can generate detailed maps of station premises. For example, the map generation unit uses generative AI to generate detailed maps including the locations of elevators and escalators in the station premises. The voice guidance unit provides voice guidance based on the map generated by the map generation unit. For example, the voice guidance unit uses generative AI to generate voice guidance for visually and hearing-impaired persons. The voice guidance unit can also provide real-time voice guidance. Furthermore, the voice guidance unit can provide voice guidance according to the user's emotional state. For example, the voice guidance unit uses generative AI to analyze the user's emotional state and provide voice guidance that gives a sense of security. Thus, the tactile paving MAP generation app according to the embodiment can support visually and hearing-impaired persons in safely and efficiently reaching their destinations using public transportation. For example, the tactile paving MAP generation app provides route guidance based on the latest operation status and tactile paving information. By proposing optimal routes using past data, users can avoid congestion and move smoothly. With detailed maps of station premises and voice guidance, users can move without getting lost even in complex station premises.

The operation status acquisition unit can simultaneously collect weather and disaster information and propose safe routes to users. For example, when the generative AI collects operation status and tactile paving information, it acquires weather data in real time and proposes routes according to weather changes. For example, in the event of heavy rain or strong winds, indoor routes are preferentially guided. The operation status acquisition unit also collects disaster information and generates routes that respond to emergencies such as earthquakes and floods. For example, in the event of an earthquake, it proposes routes including evacuation routes. Furthermore, the operation status acquisition unit generates routes that allow users to move safely based on weather and disaster information and updates them in real time. For example, in the event of heavy rain, it guides users along routes with low flood risk. In this way, it is possible to provide users with routes that allow them to move safely.

The map generation unit can analyze the user's movement history and provide individually optimized routes. For example, the map generation unit uses generative AI to analyze the user's past movement history and propose individually optimized routes. For example, it generates routes considering routes used in the past and preferred means of transportation. The map generation unit also proposes routes to avoid congestion based on the user's movement history. For example, it predicts crowded time periods from past data and guides users to move during less crowded times. Furthermore, the map generation unit analyzes the user's movement history and proposes routes that include facilities and services preferred by the user. For example, it generates routes that pass by cafes or restaurants visited in the past. In this way, it is possible to provide users with individually optimized routes.

The map generation unit can preferentially propose routes that give the user a sense of security by using an emotion estimation function. For example, the map generation unit proposes routes that give the user a sense of security using the emotion estimation function. For example, it preferentially guides the user along routes that have been safely used in the past based on movement history. The map generation unit also analyzes the user's real-time emotional state and generates routes that provide a sense of security. For example, if the user feels anxious, it proposes less crowded routes. Furthermore, the map generation unit dynamically updates routes that give the user a sense of security using the emotion estimation function. For example, if the user's emotions change during movement, it immediately regenerates the route. In this way, it is possible to provide routes that give the user a sense of security.

The map generation unit can also provide route guidance for elderly people and children other than visually and hearing-impaired persons. For example, the map generation unit uses generative AI to provide route guidance for elderly people based on collected information. For example, it proposes routes that prioritize the use of elevators and escalators. The map generation unit also generates safe routes for children using generative AI to provide route guidance for children. For example, it guides users along routes that pass through roads with little traffic or parks. Furthermore, the map generation unit collects barrier-free information using generative AI and provides it to users to offer route guidance for elderly people and children. For example, it proposes routes with few steps or with handrails. In this way, it is possible to provide route guidance for elderly people and children.

The map generation unit can also provide access information to tourist spots and event venues. For example, the map generation unit uses generative AI to collect information on tourist spots and provide access information for visually and hearing-impaired persons. For example, it proposes routes that include tactile paving and voice guidance information within tourist spots. The map generation unit also collects event information using generative AI to provide access information to event venues and generates optimal routes. For example, it guides users along routes that take into account congestion at event venues. Furthermore, the map generation unit collects real-time operation status of public transportation using generative AI to provide access information to tourist spots and event venues. For example, it proposes routes based on the operation status of trains and buses. In this way, it is possible to provide access information to tourist spots and event venues.

The map generation unit can propose routes that prevent the user from feeling stress by using an emotion estimation function. For example, the map generation unit proposes routes that prevent the user from feeling stress using the emotion estimation function. For example, it preferentially guides the user along less crowded or quiet routes. The map generation unit also analyzes the user's real-time emotional state and generates routes that reduce stress. For example, if the user feels stressed, it proposes relaxing routes. Furthermore, the map generation unit dynamically updates routes that prevent the user from feeling stress using the emotion estimation function. For example, if the user's emotions change during movement, it immediately regenerates the route. In this way, it is possible to provide routes that prevent the user from feeling stress.

The map generation unit can analyze past data, learn the user's movement patterns, and predict future movements. For example, the map generation unit uses generative AI to analyze past movement data and learn the user's movement patterns. For example, it predicts routes used on specific days of the week or at specific times and proposes future movements. The map generation unit also predicts future movements based on the user's past movement history. For example, it predicts routes and time periods frequently used by the user from past data and proposes optimal routes. Furthermore, the map generation unit uses generative AI to analyze past data and learn the user's movement patterns to predict future movements. For example, it predicts movement patterns according to seasonal or weather changes and proposes routes. In this way, it is possible to predict the user's future movements and provide optimal routes.

The map generation unit can propose personalized routes that take into account the user's preferences and habits based on past data. For example, the map generation unit uses generative AI to analyze past data and learn the user's preferences and habits. For example, for users who prefer certain cafes or restaurants, it proposes routes that pass by those places. The map generation unit also proposes personalized routes based on the user's past movement history. For example, it generates routes considering routes used at specific times and preferred means of transportation. Furthermore, the map generation unit uses generative AI to propose routes that take into account the user's preferences and habits based on past data. For example, it generates routes that pass by scenic or quiet places preferred by the user. In this way, it is possible to provide personalized routes based on the user's preferences and habits.

The map generation unit can identify the routes with which the user was most satisfied from past data using an emotion estimation function and propose similar routes. For example, the map generation unit identifies the routes with which the user was most satisfied from past data using the emotion estimation function. For example, it analyzes past movement history and emotional data to extract highly satisfying routes. The map generation unit also identifies highly satisfying routes based on the user's past emotional data and proposes similar routes. For example, it generates routes with similar conditions to those with which the user was satisfied in the past. Furthermore, the map generation unit identifies the routes with which the user was most satisfied from past data using the emotion estimation function and proposes similar routes. For example, it learns the characteristics of highly satisfying routes and generates new routes based on them. In this way, it is possible to provide similar routes based on the routes with which the user was most satisfied.

The map generation unit can propose optimal routes from a global perspective by comparing the user's movement patterns in other cities or countries based on past data. For example, the map generation unit uses generative AI to analyze past data and compare the user's movement patterns in other cities or countries. For example, it proposes optimal routes based on movement data from different cities. The map generation unit also analyzes movement patterns in other countries and proposes optimal routes from a global perspective. For example, it generates routes that take into account different cultures and transportation systems. Furthermore, the map generation unit uses generative AI to compare the user's movement patterns in other cities or countries based on past data and propose optimal routes. For example, it guides users along routes that take into account congestion and transportation means in different cities. In this way, it is possible to provide optimal routes from a global perspective.

The map generation unit can provide route guidance according to specific events or seasons based on past data. For example, the map generation unit uses generative AI to analyze past data and provide route guidance according to specific events. For example, it proposes optimal routes during fireworks festivals or festivals. The map generation unit also provides route guidance according to the season by generating optimal routes based on past data using generative AI. For example, it guides users along routes that pass by cherry blossom viewing spots during the cherry blossom season. Furthermore, the map generation unit uses generative AI to provide route guidance according to specific events or seasons based on past data. For example, it proposes routes that pass by illumination spots during the Christmas season. In this way, it is possible to provide route guidance according to specific events or seasons.

The map generation unit can identify routes where the user felt anxiety from past data using an emotion estimation function and propose improvements. For example, the map generation unit identifies routes where the user felt anxiety from past data using the emotion estimation function. For example, it analyzes past movement history and emotional data to extract routes where anxiety was felt. The map generation unit also identifies routes where anxiety was felt based on the user's past emotional data and proposes improvements. For example, it generates alternative routes for routes where anxiety was felt. Furthermore, the map generation unit identifies routes where the user felt anxiety from past data using the emotion estimation function and proposes improvements. For example, it learns the characteristics of routes where anxiety was felt and generates new routes based on them. In this way, it is possible to identify routes where the user felt anxiety and provide improvements.

The map generation unit can analyze real-time human flow when generating detailed maps of station premises and propose routes to avoid congestion. For example, the map generation unit uses generative AI to analyze real-time human flow when generating detailed maps of station premises and propose routes to avoid congestion. For example, it guides users along less crowded passages by avoiding crowded areas. The map generation unit also collects data from surveillance cameras and sensors in the station premises and analyzes real-time human flow. For example, it identifies areas where congestion is occurring and notifies users. Furthermore, the map generation unit uses generative AI to analyze real-time human flow and dynamically update routes to avoid congestion. For example, if congestion is resolved, it re-proposes the shortest route. In this way, it is possible to provide routes that avoid congestion.

The map generation unit can track the user's location information in real time when generating detailed maps of station premises and dynamically update routes. For example, the map generation unit uses generative AI to track the user's location information in real time and dynamically update detailed maps of station premises. For example, it recalculates the optimal route each time the user moves. The map generation unit also acquires location information from the user's smartphone or wearable device and provides real-time route guidance. For example, when the user approaches an elevator, it guides the next action. Furthermore, the map generation unit uses generative AI to dynamically update detailed maps of station premises based on the user's location information and propose optimal routes. For example, as the user approaches the destination, it finely adjusts the route. In this way, it is possible to track the user's location information in real time and dynamically update routes.

The voice guidance unit can provide voice guidance that allows the user to move with peace of mind by using an emotion estimation function. For example, the voice guidance unit provides voice guidance that allows the user to move with peace of mind using the emotion estimation function. For example, if the user feels anxious, it adds encouraging messages. The voice guidance unit also analyzes the user's real-time emotional state and generates voice guidance that provides a sense of security. For example, it provides guidance in a tone that allows the user to relax. Furthermore, the voice guidance unit dynamically updates voice guidance that allows the user to move with peace of mind using the emotion estimation function. For example, if the user's emotions change, it immediately adjusts the voice guidance. In this way, it is possible to provide voice guidance that allows the user to move with peace of mind.

The map generation unit can also provide guidance for other complex facilities such as shopping malls and airports based on detailed maps of station premises. For example, the map generation unit uses generative AI to provide guidance for shopping malls based on detailed maps of station premises. For example, it proposes routes that include store locations, elevators, and escalator information. The map generation unit also generates detailed maps of airports using generative AI to provide guidance for airports. For example, it guides users to the locations of check-in counters and gates. Furthermore, the map generation unit uses generative AI to generate detailed maps of other complex facilities and provide guidance for visually and hearing-impaired persons. For example, it provides route guidance within large event venues or hospitals. In this way, it is possible to provide guidance for other complex facilities such as shopping malls and airports.

The map generation unit can provide visual guidance displays based on detailed maps of station premises and support users other than visually impaired persons. For example, the map generation unit uses generative AI to provide visual guidance displays based on detailed maps of station premises. For example, it displays guidance on digital signage or smartphone apps. The map generation unit also provides visual guidance displays using generative AI to support users other than visually impaired persons. For example, it provides guidance using maps or pictograms. Furthermore, the map generation unit uses generative AI to provide visual guidance displays based on detailed maps of station premises so that users can intuitively understand the guidance. For example, it displays guidance using color coding or icons. In this way, it is possible to provide visual guidance displays that support users other than visually impaired persons.

The voice guidance unit can provide voice guidance that prevents the user from feeling stress by using an emotion estimation function. For example, the voice guidance unit provides voice guidance that prevents the user from feeling stress using the emotion estimation function. For example, it provides guidance in a tone that allows the user to relax. The voice guidance unit also analyzes the user's real-time emotional state and generates voice guidance that reduces stress. For example, if the user feels stressed, it provides guidance in a calm voice. Furthermore, the voice guidance unit dynamically updates voice guidance that prevents the user from feeling stress using the emotion estimation function. For example, if the user's emotions change, it immediately adjusts the voice guidance. In this way, it is possible to provide voice guidance that prevents the user from feeling stress.

The system according to the embodiment is not limited to the above examples and can be variously modified, for example, as follows.

The tactile paving MAP generation app can further include a health status acquisition unit that monitors the user's health status. For example, the health status acquisition unit monitors the user's heart rate and blood pressure in real time and, if an abnormality is detected, proposes a route to the nearest medical facility. The health status acquisition unit can also analyze the user's walking speed and fatigue level and, if a break is needed, guide the user along a route that includes rest spots. Furthermore, the health status acquisition unit can generate a route that does not overburden the user based on the user's health data. For example, for users who have difficulty walking for long periods, it proposes routes that prioritize short-distance movement.

The tactile paving MAP generation app can further include a recommendation unit that proposes tourist spots and restaurants according to the user's preferences. For example, the recommendation unit analyzes the user's past visit history and evaluation data and proposes tourist spots that the user prefers. The recommendation unit can also guide the user to nearby restaurants and cafes based on the user's current location and movement route. Furthermore, the recommendation unit can provide event information according to the user's preferences. For example, if the user likes music events, it provides information on concerts held nearby.

The tactile paving MAP generation app can further include an emergency notification unit to ensure the user's safety during movement. For example, the emergency notification unit provides a function to call the police or ambulance with one touch when the user encounters an emergency. The emergency notification unit can also automatically send the user's current location to the notification destination to enable a prompt response. Furthermore, the emergency notification unit can include a function to send emergency notifications to the user's family or friends. For example, it sends a message including the current location and details of the emergency to a contact specified by the user.

The tactile paving MAP generation app can further include an entertainment unit that provides entertainment to the user during movement. For example, the entertainment unit provides a function to play music or audiobooks according to the user's preferences. The entertainment unit can also provide audio guidance on the history and culture related to the user's movement route. Furthermore, the entertainment unit can provide quizzes and games that the user can enjoy while moving. For example, it presents quizzes about places the user visits and introduces a system where points are accumulated for correct answers.

The tactile paving MAP generation app can further include a communication unit that supports communication for the user during movement. For example, the communication unit provides a function that allows the user to chat with other users in real time. The communication unit can also provide a function for the user to contact other users nearby. Furthermore, the communication unit can include a bulletin board function that allows the user to post questions or consultations while moving. For example, if the user gets lost, they can receive advice from other users.

The tactile paving MAP generation app can further provide relaxation functions according to the user's emotional state. For example, the relaxation function plays relaxing music or natural sounds when the user feels anxious. The relaxation function can also analyze the user's emotional state and provide breathing techniques or meditation guides to reduce stress. Furthermore, the relaxation function can display visual content that allows the user to relax. For example, if the user is using a smartphone, it displays beautiful landscapes or works of art.

The tactile paving MAP generation app can further provide customized voice guidance according to the user's emotional state. For example, if the user is nervous, the voice guidance is provided in a gentle and calm tone. If the user is tired, encouraging messages can also be added. Furthermore, the voice guidance can analyze the user's emotional state in real time and dynamically adjust the optimal guidance method. For example, if the user is relaxed, the guidance is provided in a cheerful tone.

The tactile paving MAP generation app can further provide personalized routes according to the user's emotional state. For example, if the user feels anxious, it preferentially guides the user along routes that provide a sense of security. If the user is relaxed, it can also propose scenic routes. Furthermore, it analyzes the user's emotional state in real time and, if the user's emotions change during movement, immediately regenerates the route. For example, if the user starts to feel stressed, it proposes quiet routes.

The tactile paving MAP generation app can further provide emergency response functions according to the user's emotional state. For example, if the user falls into extreme anxiety or panic, the emergency notification function is automatically activated. It can also analyze the user's emotional state in real time and provide access to counseling services as needed. Furthermore, if the user is emotionally unstable, it can guide the user to a nearby safe place. For example, if the user is in a panic state, it proposes routes to the nearest police station or hospital.

The tactile paving MAP generation app can further provide feedback functions according to the user's emotional state. For example, it records the emotions the user felt during movement so that they can be reviewed later. It can also propose improvements to movement routes or guidance methods based on the user's emotional data. Furthermore, it can provide a function for the user to share the emotions they felt during movement with other users. For example, the user can share the sense of security or anxiety they felt on a particular route with other users for reference.

Below is a brief explanation of the processing flow of Example 2 of the Embodiment.

Step 1: The operation status acquisition unit acquires the operation status of each public transportation facility. For example, it acquires train delay information, bus operation status, and subway operation status in real time. The operation status acquisition unit acquires transportation operation information via an API and updates it in real time.

Step 2: The tactile paving information acquisition unit acquires tactile paving information from each local government. For example, it acquires installation locations, status information, and update information of tactile paving. The tactile paving information acquisition unit acquires tactile paving information from the local government database and reflects the latest information.

Step 3: The map generation unit generates a map based on the information acquired by the operation status acquisition unit and the tactile paving information acquisition unit. For example, it uses generative AI to generate a map reflecting the latest operation status and tactile paving information. Furthermore, it can propose optimal routes based on past data or generate detailed maps of station premises.

Step 4: The voice guidance unit provides voice guidance based on the map generated by the map generation unit. For example, it uses generative AI to generate voice guidance for visually and hearing-impaired persons, and provides real-time voice guidance or voice guidance according to the user's emotional state.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

### Second Embodiment

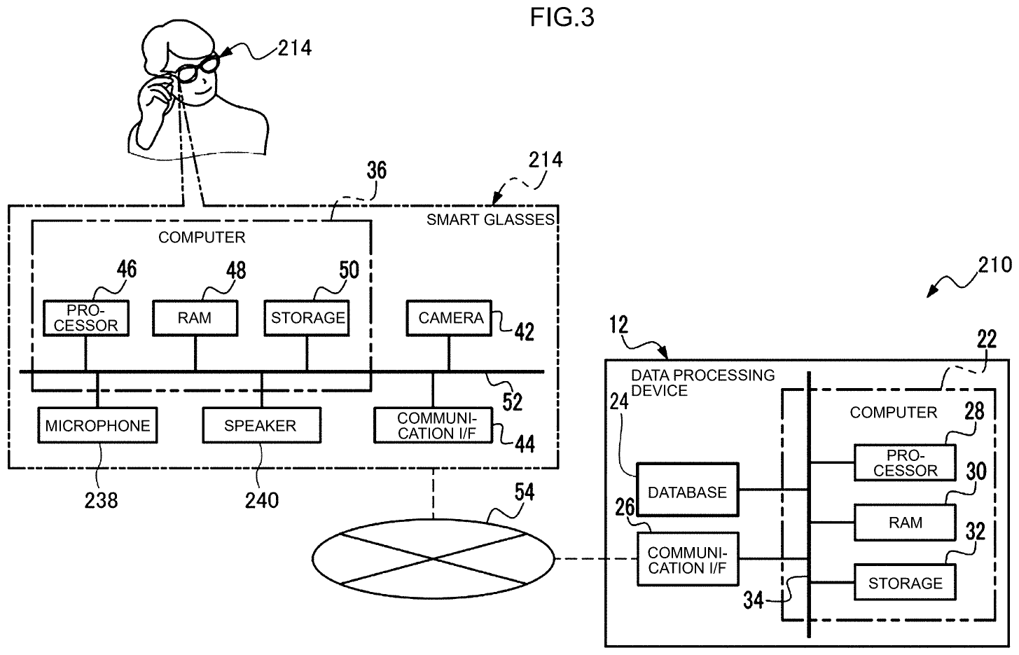

FIG. 3 shows an example of the configuration of a data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 include a computer 36, a microphone 238, a speaker 240, a camera 42, and a communication I/F 44. The computer 36 includes a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

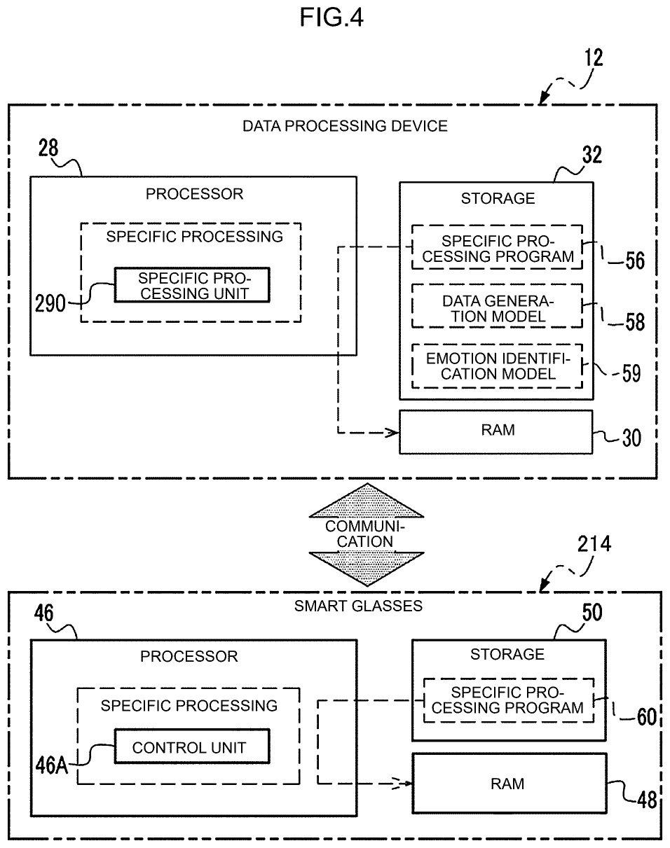

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

### Third Embodiment

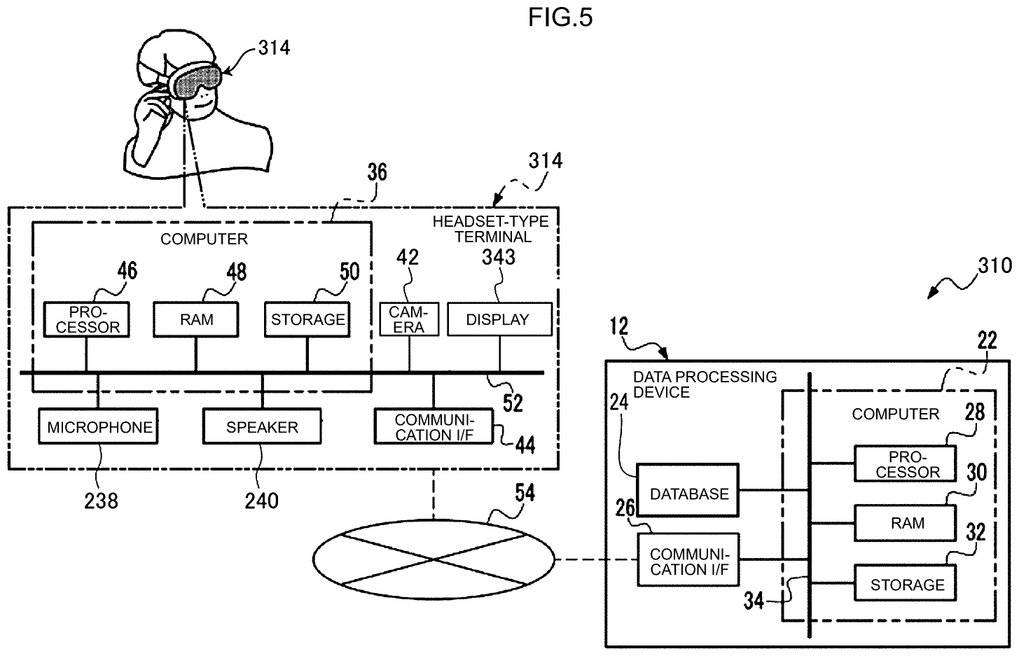

FIG. 5 shows an example of the configuration of a data processing system 310 according to the third embodiment.

### Third Embodiment

FIG. 5 shows an example configuration of a data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 includes a computer 36, a microphone 238, a speaker 240, a camera 42, a communication I/F 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

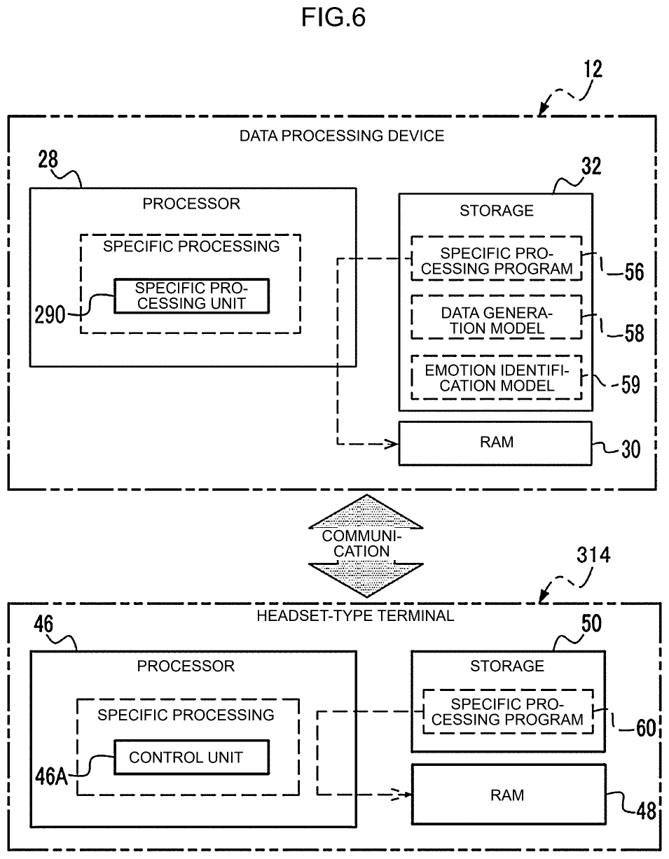

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

### Fourth Embodiment

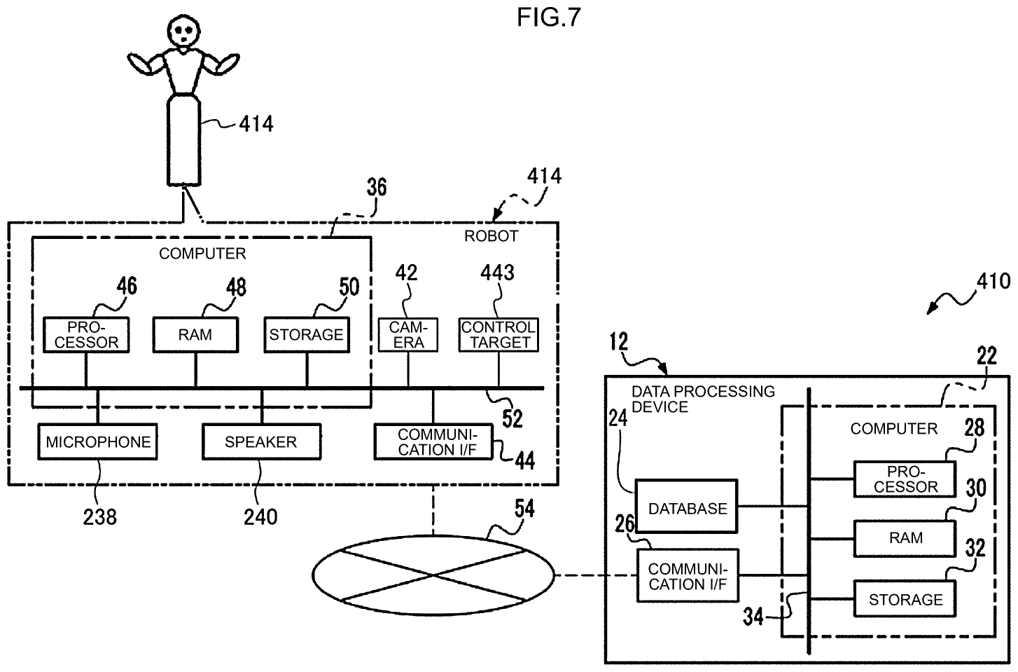

FIG. 7 shows an example of the configuration of a data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 includes a computer 36, a microphone 238, a speaker 240, a camera 42, a communication I/F 44, and a control target 443. The computer 36 includes a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

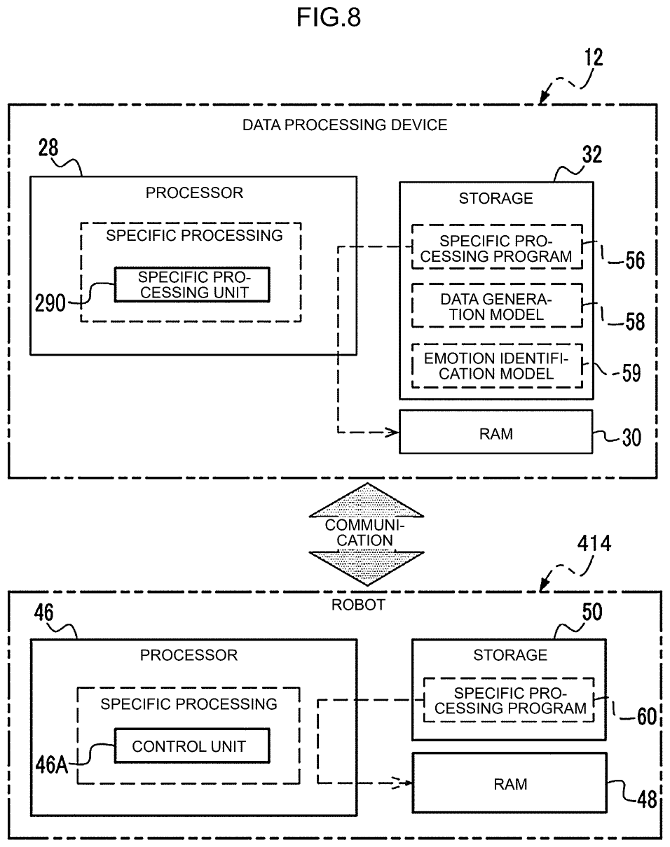

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

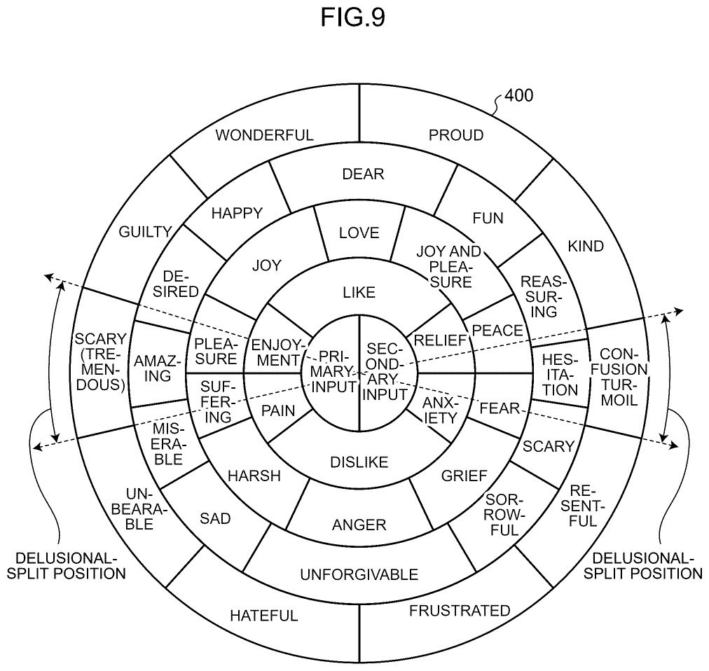

The emotion identification model 59 as an emotion engine may determine the user's emotion according to a specific mapping. Specifically, the emotion identification model 59 may determine the user's emotion according to an emotion map (see FIG. 9), which is a specific mapping. The emotion identification model 59 may also determine the robot's emotion, and the specific processing unit 290 may perform specific processing using the robot's emotion.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

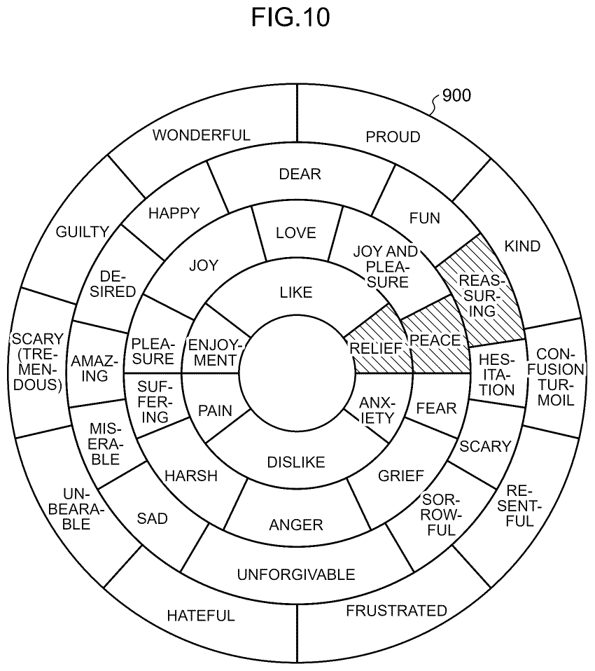

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

What is claimed is:

1. A system comprising: an operation status acquisition unit that acquires the operation status of each public transportation facility; a tactile paving information acquisition unit that acquires tactile paving information from each local government; a map generation unit that generates a map based on the information acquired by the operation status acquisition unit and the tactile paving information acquisition unit; and a voice guidance unit that provides voice guidance based on the map generated by the map generation unit.

2. The system according to claim 1, wherein the operation status acquisition unit simultaneously collects weather and disaster information and proposes a safe route to the user.

3. The system according to claim 1, wherein the map generation unit analyzes the user's movement history and provides a route individually optimized for the user.

4. The system according to claim 1, wherein the map generation unit preferentially proposes routes that allow the user to feel a sense of security.

5. The system according to claim 1, wherein the map generation unit also provides route guidance for elderly people and children other than visually and hearing-impaired persons.
